(19) United States
(12) Patent Application Publication
(10) Pub. No.: US 2021/0270772 A1
(43) Pub. Date: Sep. 2, 2021

(54) ELECTROPHORESIS APPARATUS

(71) Applicant: SHIMADZU CORPORATION, Kyoto-shi (JP)

(72) Inventor: Akihiro ARAI, Kyoto-shi (JP)

(73) Assignee: SHIMADZU CORPORATION, Kyoto-shi (JP)

(21) Appl. No.: 17/180,126

(22) Filed: Feb. 19, 2021

(30) Foreign Application Priority Data
Feb. 21, 2020 (JP) 2020-028404

(51) Int. Cl. G01N 27/447; G01N 35/00

(52) U.S. Cl. CPC G01N 27/44704; G01N 27/44791; G01N 35/00594

(57) ABSTRACT

An electrophoresis apparatus includes an electrophoresis mechanism that perform electrophoresis of a sample with a microchip, a controller that determines whether or not the microchip satisfies a criterion for performance of the microchip, and a cleaning mechanism that performs first cleaning for cleaning a device with cleaning water and second cleaning for cleaning the device with a cleaning solution different from cleaning water. The cleaning mechanism performs second cleaning onto the device when the device is determined as not satisfying the criterion.

### BACKGROUND OF THE INVENTION

### Field of the Invention

The present invention relates to an electrophoresis apparatus.

### Description of the Background Art

An electrophoresis apparatus separates a sample by electrophoresis with a device such as a microchip or a capillary. For example, Japanese Patent No. 3884911 discloses an electrophoresis apparatus that introduces a sample into a device and separates the sample. Devices are mass produced and mainly used in single-use applications. Japanese Patent No. 3884911, however, discloses repeated use of a device by cleaning the device.

### SUMMARY OF THE INVENTION

In order to maintain performance of a device, an electrophoresis apparatus may clean the device with water or a specific solution different from water. Though Japanese Patent No. 3884911 discloses a configuration where a device in a form of a plate-shaped member is attachable to and removable from a main body so as to readily be cleaned, it fails to disclose a specific cleaning method and a criterion for determination as to whether or not to clean the device. Therefore, in the electrophoresis apparatus described in Japanese Patent No. 3884911, even a device to basically be cleaned with a specific solution may not be cleaned therewith, and in this case, primary performance of the device may not be maintained.

An object of the present disclosure is to provide an efficient cleaning technique for retaining primary performance of a device to repeatedly be used.

An electrophoresis apparatus according to one aspect of the present disclosure includes an electrophoresis mechanism that performs electrophoresis of a sample with a device, a control device that determines whether or not the device satisfies a criterion for performance of the device, and a cleaning mechanism that performs first cleaning for cleaning the device with cleaning water and second cleaning for cleaning the device with a cleaning solution different from cleaning water. The cleaning mechanism performs second cleaning onto the device when the device is determined as not satisfying the criterion.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram schematically showing an overall configuration of an electrophoresis apparatus.

FIG. 2 is a diagram schematically showing a configuration of a main portion of the electrophoresis apparatus.

FIGS. 3A to 3C and 4 are diagrams showing an exemplary microchip.

FIG. 5 is a diagram schematically showing a state of connection between an air supply port of a pressurization and suction portion and a microchip.

FIG. 6 is a block diagram showing a control configuration of a controller.

FIG. 7 is a diagram showing a flag.

FIG. 8 is a diagram showing the number of theoretical plates as an electrophoresis parameter.

FIG. 9 is a diagram showing a symmetry factor as an electrophoresis parameter.

FIG. 10 is a diagram showing a peak detection time period as an electrophoresis parameter.

FIG. 11 is a diagram showing signal intensity of a microchip that satisfies a performance criterion.

FIG. 12 is a diagram showing signal intensity of a microchip that does not satisfy the performance criterion.

FIG. 13 is a diagram showing a noise level.

FIG. 14 is a diagram showing signal intensity of a microchip that satisfies a performance criterion.

FIG. 15 is a diagram showing signal intensity of a microchip that does not satisfy the performance criterion.

FIG. 16 is a diagram showing an exemplary flow of processing in the electrophoresis apparatus.

FIG. 17 is a diagram showing an exemplary flow of a pre-process in the electrophoresis apparatus.

FIG. 18 is a diagram showing an exemplary flow of cleaning treatment in the electrophoresis apparatus.

FIG. 19 is a flowchart showing a flow of processing in an electrophoresis apparatus in a comparative example.

FIG. 20 is a diagram showing correspondence between a flag and an elapsed period.

FIG. 21 is a diagram showing correspondence between a flag and the number of times of use.

FIG. 22 is a diagram for illustrating third cleaning.

FIG. 23 is a diagram showing a cleaning method corresponding to each type of a sample.

### DESCRIPTION OF THE PREFERRED EMBODIMENTS

An embodiment of the present disclosure will be described below in detail with reference to the drawings. The same or corresponding elements in the drawings have the same reference characters allotted and description thereof will not be repeated.

[Overall Configuration of Microchip Electrophoresis Apparatus]

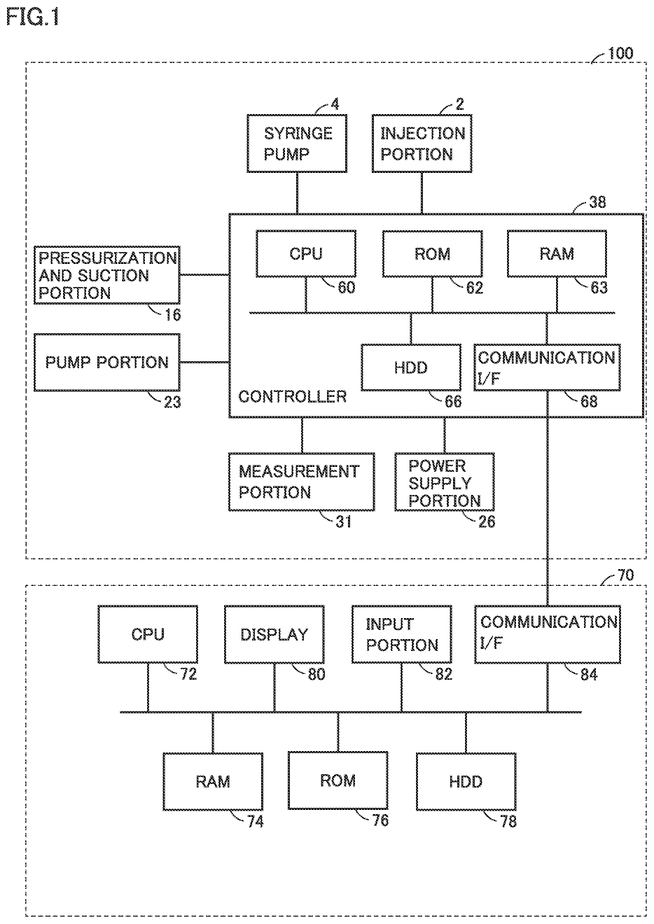

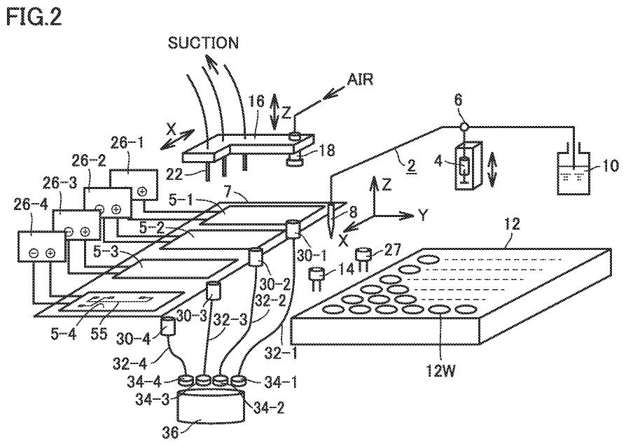

FIG. 1 is a diagram schematically showing an overall configuration of a microchip electrophoresis apparatus according to an embodiment of the present invention. A microchip electrophoresis apparatus is abbreviated as an “electrophoresis apparatus 100” below. FIG. 2 is a diagram schematically showing a configuration of a main portion of electrophoresis apparatus 100 shown in FIG. 1. Referring to FIG. 1, electrophoresis apparatus 100 includes an injection portion 2, a syringe pump 4, a pressurization and suction portion 16, a pump portion 23, a power supply portion 26, a measurement portion 31, and a controller 38. Electrophoresis apparatus 100 is communicatively connected to a control device 70.

Referring to FIG. 2, electrophoresis apparatus 100 further includes a plurality of (for example, four) microchips 5-1 to 5-4, a holder 7, and a plate 12.

Each of microchips 5-1 to 5-4 includes one electrophoresis flow channel for processing one sample. Examples of the sample include nucleic acid, protein, and glycan. During an analysis operation, microchips 5-1 to 5-4 are held by holder 7. Microchips 5-1 to 5-4 may collectively be referred to as a microchip 5 below. Microchip 5 can repeatedly be used.

Injection portion 2 injects a separation buffer and a sample into microchips 5-1 to 5-4. The separation buffer is used also as a “separation medium” and contains, for example, at least one of a pH buffer and a water soluble polymer (a cellulose based polymer etc.). Injection portion 2 implements a “movement mechanism” that moves an injection probe 8 between a position of suction of liquid to be injected and an injection position above microchip 5. Specifically, injection portion 2 includes injection probe 8, a syringe pump 4, a container 10 that holds cleaning water, and a three-way electromagnetic valve 6.

Injection probe 8 includes an injection nozzle. Syringe pump 4 suctions and delivers mainly a separation buffer, a sample, cleaning water, and a cleaning solution. Injection probe 8 and at least one container 10 are connected to syringe pump 4 with three-way electromagnetic valve 6 being interposed.

A sample is accommodated in a well 12W in plate 12 and injected into microchips 5-1 to 5-4 by injection portion 2. The separation buffer is accommodated in a not-shown container and injected into microchips 5-1 to 5-4 by injection portion 2.

Pressurization and suction portion 16 implements a “loading mechanism” that fills an electrophoresis flow channel in microchip 5 with the separation buffer as being pressurized. Pump portion 23 implements a suction mechanism that suctions a solution from the reservoirs in microchips 5-1 to 5-4. Though a plurality of mechanisms are disclosed in the present embodiment, at least one of components that make up one mechanism among the plurality of mechanisms may be common to at least one of components that make up another mechanism. Pressurization and suction portion 16 loads a certain amount of separation buffer into one reservoir in the electrophoresis flow channel and fills the electrophoresis flow channel with the loaded separation buffer from the reservoir by means of an air pressure. Pressurization and suction portion 16 includes an air supply port 18 and a suction nozzle 22. Pump portion 23 discharges an unnecessary separation buffer that has overflowed into another reservoir. Pressurization and suction portion 16 and pump portion 23 are provided in common to four microchips 5-1 to 5-4.

Injection portion 2 suctions the separation buffer or the sample into injection probe 8 by connection of three-way electromagnetic valve 6 in a direction of connection of injection probe 8 and syringe pump 4. When injection portion 2 moves injection probe 8 to a position above microchips 5-1 to 5-4, injection portion 2 has syringe pump 4 deliver the separation buffer or the sample to a reservoir in the electrophoresis flow channel in any of microchips 5-1 to 5-4.

A first cleaning solution is accommodated in a first cleaning portion 14. A second cleaning solution is accommodated in a second cleaning portion 27. Though second cleaning portion 27 is similar in shape to first cleaning portion 14 for the sake of brevity of the drawings in the example in FIG. 2, second cleaning portion 27 may be in another shape. For example, second cleaning portion 27 may be in a shape like container 10.

Cleaning water typically serves to wash away a separation buffer attached to microchip 5. The cleaning solution is different from cleaning water, and it may be, for example, a solution containing an organic solvent or a surfactant. The cleaning solution typically serves to wash away a sample attached to microchip 5. Details of the cleaning solution are disclosed, for example, in Japanese Patent No. 5640557.

In cleaning injection probe 8, injection portion 2 switches three-way electromagnetic valve 6 to a direction of connection of syringe pump 4 and container 10 for cleaning water and suctions cleaning water into syringe pump 4. Then, injection portion 2 moves injection probe 8 to a waste fluid port (not shown), switches three-way electromagnetic valve 6 to a side of connection of syringe pump 4 and injection probe 8, and has injection probe 8 cleaned by discharging cleaning water from the inside of injection probe 8.

In cleaning the electrophoresis flow channel in microchips 5-1 to 5-4 with cleaning water, injection portion 2 switches three-way electromagnetic valve 6 to the direction of connection of syringe pump 4 and container 10 and suctions cleaning water into syringe pump 4. Injection portion 2 moves injection probe 8 to a reservoir of microchips 5-1 to 5-4 and injects a prescribed amount of cleaning water into the reservoir. Air is blown through air supply port 18 of pressurization and suction portion 16 to push cleaning water injected into the reservoir into the electrophoresis flow channel, and pump portion 23 suctions through suction nozzle 22, cleaning water that has overflowed from another reservoir to discharge cleaning water to the outside. In cleaning the electrophoresis flow channel with a cleaning solution, three-way electromagnetic valve 6 is switched to a state of connection of syringe pump 4 and injection probe 8, and for example, the first cleaning solution accommodated in the first cleaning portion is suctioned into injection probe 8. As a prescribed amount of cleaning solution is moved to a reservoir in microchips 5-1 to 5-4 and the prescribed amount of cleaning solution is injected into the reservoir, the cleaning solution enters the electrophoresis flow channel owing to a capillary phenomenon.

Pressurization and suction portion 16 is used also in discharging the cleaning solution after it is held in the electrophoresis flow channel for a prescribed time period.

In filling the electrophoresis flow channel with a separation buffer, pressurization and suction portion 16 moves to a position above microchips 5-1 to 5-4, presses air supply port 18, as being maintained in a hermetic state, against a reservoir (a reservoir into which the separation buffer has been injected) at one end of the electrophoresis flow channel in microchips 5-1 to 5-4, and inserts suction nozzle 22 into another reservoir. In this state, air is blown through air supply port 18 to push the separation buffer into the electrophoresis flow channel, and pump portion 23 suctions through suction nozzle 22, the separation buffer that has overflowed from another reservoir to discharge the separation buffer to the outside. This is similarly applicable also to discharging of the cleaning solution in the electrophoresis flow channel Air supply port 18 is pressed, as being maintained in the hermetic state, against the reservoir at one end of microchips 5-1 to 5-4, and suction nozzle 22 is inserted in another reservoir. In this state, air is blown through air supply port 18 to push the cleaning solution into the electrophoresis flow channel, and pump portion 23 suctions the cleaning solution that has overflowed from another reservoir through suction nozzle 22 to discharge the cleaning solution to the outside.

Power supply portion 26 includes a plurality of (for example, four) high-voltage power supplies 26-1 to 26-4 independent for each microchip 5 in order to independently apply a voltage for electrophoresis to the electrophoresis flow channel in each of microchips 5-1 to 5-4.

Measurement portion 31 detects a sample component migrated and separated in a separation flow channel 55 in each of microchips 5-1 to 5-4. Specifically, measurement portion 31 includes a plurality of (for example, four) light emitting diodes (LEDs) 30-1 to 30-4, a plurality of (for example, four) optical fibers 32-1 to 32-4, a plurality of (for example, four) filters 34-1 to 34-4, and a photomultiplier tube 36.

LEDs 30-1 to 30-4 each emit excitation light to a part of the electrophoresis flow channel in microchips 5-1 to 5-4. Optical fibers 32-1 to 32-4 receive fluorescence generated by excitation by excitation light from LEDs 30-1 to 30-4, of the sample component that moves through the electrophoresis flow channel Filters 34-1 to 34-4 remove an excitation light component from fluorescence from optical fibers 32-1 to 32-4 and allow passage only of a fluorescent component. Photomultiplier tube 36 receives the fluorescent component that has passed through filters 34-1 to 34-4.

Since microchips 5-1 to 5-4 are provided with measurement units 31 independent of one another in the present embodiment, fluorescence from the plurality of microchips processed sequentially in parallel until introduction of a sample can simultaneously be detected.

By controlling LEDs 30-1 to 30-4 to emit light at different timing, single photomultiplier tube 36 can identify and detect fluorescence from the plurality of microchips 5-1 to 5-4. A source of excitation light is not limited to the LED but a laser diode (LD) may be employed.

When filling of one electrophoresis flow channel with the separation buffer and loading of the sample thereinto end, controller 38 controls an operation by injection portion 2 to make transition to filling of a next electrophoresis flow channel with the separation buffer and loading of the sample thereinto. Controller 38 controls an operation by power supply portion 26 (high-voltage power supplies 26-1 to 26-4) to apply a migration voltage to cause electrophoresis in the electrophoresis flow channel into which loading of the sample has ended. Controller 38 controls a detection operation by measurement portion 31. For repeated use of microchip 5, before the electrophoresis flow channel where analysis of a previous sample has ended is filled with the separation buffer, controller 38 further controls an operation to clean that electrophoresis flow channel.

Controller 38 includes a central processing unit (CPU) 60, a storage unit where a program and data is stored, and a communication interface (I/F) 68 as main constituent elements. The constituent elements are connected to one another through a data bus.

The storage unit includes a read only memory (ROM) 62, a random access memory (RAM) 63, and a hard disk drive (HDD) 66. ROM 62 can store a program executed by CPU 60. RAM 63 can temporarily store data generated by execution of a program by CPU 60 and data provided through communication I/F 68, and can function as a temporary data memory used as a work area. HDD 66 is a non-volatile storage device and can store information generated in electrophoresis apparatus 100 such as a result of detection by measurement portion 31. Alternatively, a semiconductor storage device such as a flash memory may be adopted instead of HDD 66.

Communication IT 68 is an interface for communication with an external apparatus including control device 70. The communication I/F is implemented by an adapter or a connector. Communication may be, for example, wireless communication such as Bluetooth® or wireless local area network (LAN) or wired communication through a universal serial bus (USB).

Control device 70 is communicatively connected to electrophoresis apparatus 100 and exchanges data with electrophoresis apparatus 100. Control device 70 controls an operation by electrophoresis apparatus 100 and takes in and processes data obtained by measurement portion 31.

Specifically, control device 70 is mainly configured with a CPU 72 serving as a computing unit. For example, a personal computer can be employed as control device 70. Control device 70 includes CPU 72, a storage unit (a ROM 76, a RAM 74, and an HDD 78), a communication I/F 84, an input portion 82, and a display 80.

ROM 76 can store a program executed by CPU 72. RAM 74 can temporarily store data generated by execution of a program by CPU 72 and data provided through communication I/F 84 or input portion 82 and can function as a temporary data memory used as a work area. HDD 78 is a non-volatile storage device and can store information generated in control device 70. Alternatively, a semiconductor storage device such as a flash memory may be adopted instead of HDD 78.

Communication I/F 84 is an interface for communication between control device 70 and an external apparatus including electrophoresis apparatus 100. Input portion 82 accepts an input operation including an instruction for electrophoresis apparatus 100 from a measurer. Input portion 82 includes a keyboard, a mouse, and a touch panel formed integrally with a display screen of display 80. Input portion 82 accepts registration of an analysis schedule for sequentially analyzing a plurality of samples as will be described later, and accepts an instruction as to timing of a step of cleaning microchip 5.

Display 80 can show a screen for input of the analysis schedule in registration of the analysis schedule. Display 80 can show a screen for input of timing of the cleaning step in giving an instruction as to timing of the step of cleaning microchip 5. During analysis and measurement or after measurement, display 80 can show detection data obtained by measurement portion 31 and a result of analysis for each sample.

[Exemplary Configuration of Microchip 5]

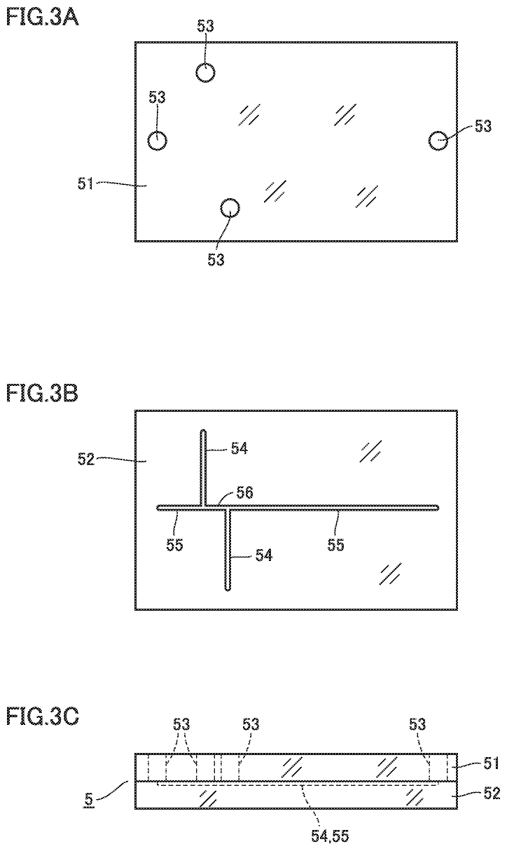

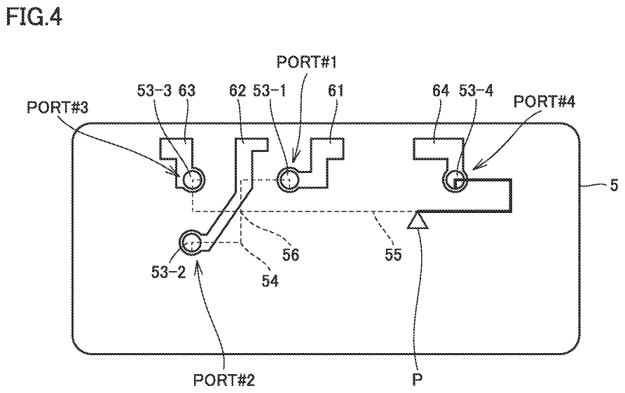

FIGS. 3A to 3C and 4 are diagrams showing exemplary microchip 5. In the specification of the present application, the “microchip” means a device for electrophoresis where an electrophoresis flow channel is provided in a substrate and it is not necessarily limited to a chip small in size.

FIG. 3A is a plan view of a transparent substrate 51 of microchip 5, FIG. 3B is a plan view of a transparent substrate 52 of microchip 5, and FIG. 3C is a front view of microchip 5.

Referring to FIG. 3C, microchip 5 includes a pair of transparent substrates 51 and 52. Transparent substrates 51 and 52 are each, for example, a glass substrate of quartz glass or other glass or a resin substrate. Transparent substrate 51 and transparent substrate 52 are bonded to each other as being superimposed on each other.

As shown in FIG. 3B, capillary grooves 54 and 55 for migration that intersect with each other are provided in a surface of transparent substrate 52. Capillary groove 55 serves as separation flow channel 55 for electrophoresis and separation of a sample. Capillary groove 54 serves as a sample introduction flow channel 54 for introduction of a sample into separation flow channel 55. Sample introduction flow channel 54 and separation flow channel 55 implement the “electrophoresis flow channel.” Sample introduction flow channel 54 and separation flow channel 55 intersect with each other at an intersection position 56.

As shown in FIG. 3A, transparent substrate 51 is provided with four through holes at positions corresponding to ends of capillary grooves 54 and 55. Four through holes serve as reservoirs 53-1 to 53-4. Reservoirs 53-1 to 53-4 may collectively be referred to as a reservoir 53 below.

Though microchip 5 is basically configured as shown in FIG. 3, for ease in handling, an electrode terminal for application of a migration voltage can be formed on microchip 5 as shown in FIG. 4. FIG. 4 is a plan view of microchip 5.

Referring to FIG. 4, four reservoirs 53-1 to 53-4 serve as ports for applying a voltage to electrophoresis flow channels 54 and 55. A port #1 (reservoir 53-1) and a port #2 (reservoir 53-2) are located at opposing ends of sample introduction flow channel 54. A port #3 (reservoir 53-3) and a port #4 (reservoir 53-4) are located at opposing ends of separation flow channel 55. In order to apply a voltage to each of ports #1 to #4, four electrode patterns 61 to 64 are formed on a surface of microchip 5 (transparent substrate 51). Electrode patterns 61 to 64 are formed to extend from respective corresponding ports to ends of microchip 5 and connected to high-voltage power supplies 26-1 to 26-4 (see FIG. 2).

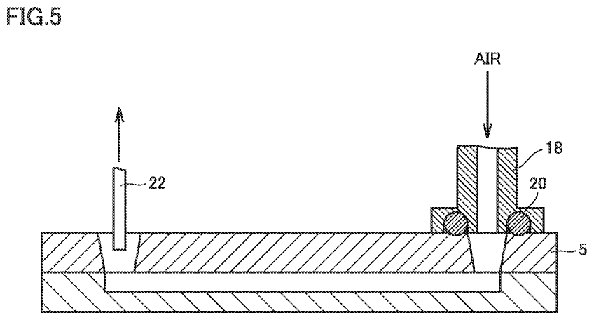

FIG. 5 is a diagram schematically showing a state of connection of air supply port 18 and suction nozzle 22 of pressurization and suction portion 16 to microchip 5.

Referring to FIG. 5, an O ring 20 is provided at a tip end of air supply port 18. By pressing air supply port 18 against one reservoir 53 of microchip 5, air supply port 18 can be attached to electrophoresis flow channel 54 or 55 of microchip 5 with hermeticity thereof being maintained. Air as being pressurized can thus be sent from air supply port 18 into electrophoresis flow channels 54 and 55. Suction nozzle 22 is inserted in another reservoir 53 and suctions and discharges unnecessary separation buffer, cleaning water, and cleaning solution that have overflowed from electrophoresis flow channels 54 and 55.

[Exemplary Functional Configuration of Controller]

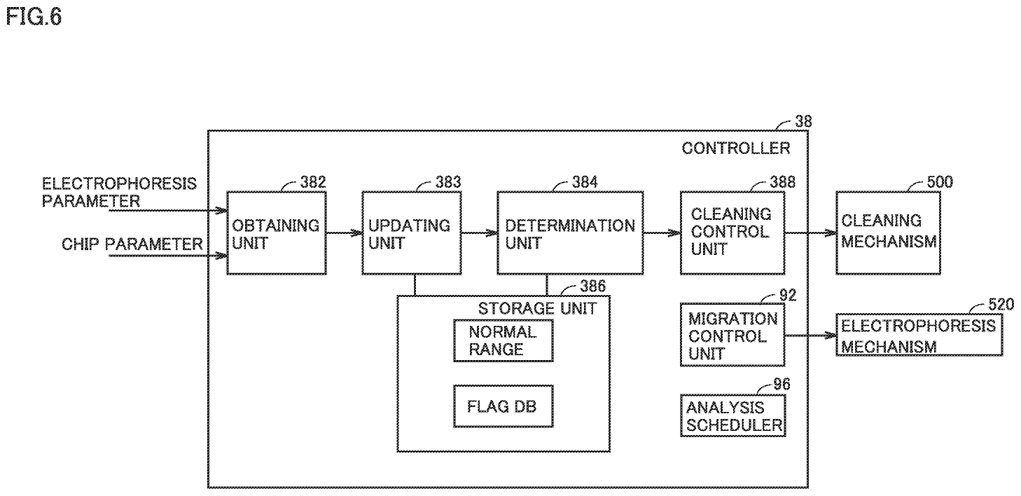

FIG. 6 is a block diagram showing a control configuration of controller 38 shown in FIG. 1. Referring to FIG. 6, controller 38 includes a migration control unit 92, a cleaning control unit 388, and an analysis scheduler 96. This functional configuration is implemented by execution of a prescribed program by CPU 60 in electrophoresis apparatus 100 shown in FIG. 1.

Controller 38 further includes functions of an obtaining unit 382, an updating unit 383, a determination unit 384, and a storage unit 386.

Migration control unit 92 controls an electrophoresis mechanism 520. Electrophoresis mechanism 520 is a mechanism to perform electrophoresis of a sample with the use of microchip 5. Electrophoresis mechanism 520 includes all components that analyze a sample. Electrophoresis mechanism 520 includes, for example, power supply portion 26, measurement portion 31, injection portion 2, pressurization and suction portion 16, and pump portion 23. Migration control unit 92 repeatedly performs a step of analysis by electrophoresis. The analysis step mainly includes (1) a buffer solution filling step of filling an empty electrophoresis flow channel with a separation buffer, (2) a sample injection step of injecting a sample into a reservoir for supply of the sample, (3) a migration and separation step of electrophoresing and separating the sample in the separation flow channel by applying a migration voltage across a plurality of reservoirs, and (4) a buffer solution removal step of removing the separation buffer in the electrophoresis flow channel and the reservoir by supplying pressurized gas from one reservoir and suctioning the separation buffer from other reservoirs.

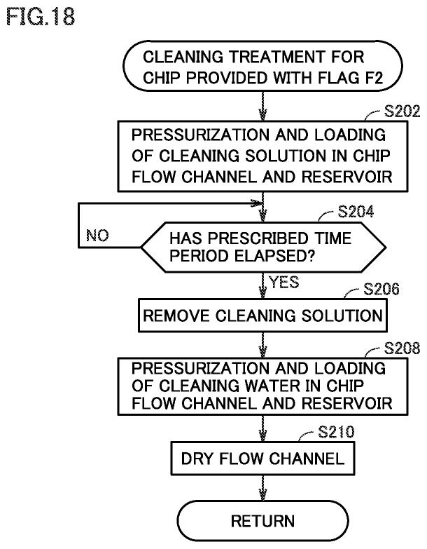

Cleaning control unit 388 has the cleaning step performed at least once for each microchip 5 based on determination by determination unit 384. At least one time of the cleaning step includes first cleaning for cleaning microchip 5 with cleaning water and second cleaning for cleaning microchip 5 with a cleaning solution. The step of first cleaning and second cleaning will be described with reference to FIG. 18.

Analysis scheduler 96 determines the order of performing a plurality of times of an analysis step and at least one time of the cleaning step for each microchip 5. Analysis scheduler 96 allocates a processing resource (a program time period and a memory) in accordance with an analysis schedule registered in advance and timing of the cleaning step to migration control unit 92 and cleaning control unit 388.

When an instruction is given through input portion 82, data indicating instruction contents is transmitted to controller 38. When controller 38 receives detection data obtained by measurement portion 31, it processes the received detection data and has display 80 show a result of processing.

Electrophoresis apparatus 100 cleans microchip 5 before electrophoresis with the use of microchip 5. Electrophoresis apparatus 100 can repeatedly use microchip 5 by cleaning of the microchip by cleaning mechanism 500. Cost for analysis can thus be reduced. When the microchip is repeatedly used, however, a component contained in a sample in previous analysis or a component contained in the separation buffer adsorbs to a surface of an inner wall of a flow channel and analysis performance tends to lower with increase in number of times of use. Therefore, electrophoresis apparatus 100 restores analysis performance of microchip 5 by cleaning the flow channel in microchip 5.

A degree of lowering in analysis performance is various depending on a frequency of analysis or a component derived from a sample. Therefore, unless a time period and a frequency required for second cleaning are clarified, effective cleaning cannot be expected. Then, electrophoresis apparatus 100 determines whether or not microchip 5 satisfies a criterion for performance (which is referred to as a “performance criterion” below) of microchip 5. Whether or not the performance criterion is satisfied is determined based on at least one parameter. When electrophoresis apparatus 100 determines that microchip 5 does not satisfy the performance criterion, it performs intensive second cleaning onto microchip 5. When electrophoresis apparatus 100 determines that microchip 5 sufficiently satisfies the performance criterion, it does not perform second cleaning onto microchip 5. When lowering in performance is expected in the future based on the number of times of use or the like, the electrophoresis apparatus performs moderate second cleaning onto microchip 5 as precautionary measures. Electrophoresis apparatus 100 can thus perform efficient second cleaning.

Regardless of whether or not microchip 5 satisfies the performance criterion, electrophoresis apparatus 100 performs first cleaning with cleaning water.

In electrophoresis apparatus 100, a flag is associated with each microchip 5. Electrophoresis apparatus 100 determines whether or not microchip 5 satisfies the performance criterion based on the flag associated with microchip 5. In electrophoresis apparatus 100 in the example in FIG. 1, four microchips 5 can be set. A user can set at least four microchips among a number of microchips 5 in electrophoresis apparatus 100.

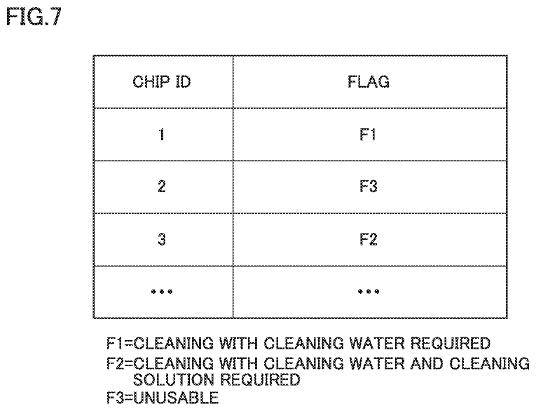

FIG. 7 is a diagram for illustrating a flag. The flag refers to information indicating a degree of necessity of cleaning of microchip 5. In the example in FIG. 7, three types of flags F1 to F3 are provided. Flag F1 indicates cleaning of microchip 5 with cleaning water without using a cleaning solution. In other words, flag F1 is associated with microchip 5 analysis performance of which has hardly lowered (or has not deteriorated). Flag F1 may be associated with microchip 5 left as being filled with the separation buffer due to a factor such as emergency stop of electrophoresis apparatus 100. Flag F2 indicates use of both of cleaning water and a cleaning solution (that is, necessity of first cleaning and second cleaning). In other words, flag F2 represents lowering in analysis performance as compared with the microchip with which flag F1 is associated. Flag F3 indicates that microchip 5 is unusable even after cleaning. In other words, flag F3 represents lowering in analysis performance as compared with the microchip with which flag F2 is associated.

Storage unit 386 stores a database in which chip identification (ID) and a flag are brought in correspondence with each other. In the example in FIG. 6, this database is shown as a flag database (DB). For example, storage unit 386 stores the flag DB shown in FIG. 7. In the example in FIG. 7, flag F1 is associated with microchip 5 with chip ID 1. In the example in FIG. 7, flag F3 is associated with microchip 5 with chip ID 2. In the example in FIG. 7, flag F2 is associated with microchip 5 with chip ID 3.

Obtaining unit 382 obtains an electrophoresis parameter and a chip parameter. The electrophoresis parameter refers to a parameter obtained by electrophoresis of a reference sample (an internal standard marker including a low-molecular-weight marker and a high-molecular-weight marker) by the electrophoresis mechanism. The reference sample includes a sample which is a mixture of a molecular weight (DNA size) standard and an internal standard marker. The reference sample is accommodated in a prescribed area (not shown).

The electrophoresis parameter corresponds to first data in the present disclosure. The chip parameter includes a parameter obtained by introduction of a separation buffer into a device by the loading mechanism. The “parameter obtained by introduction of a separation buffer into a device by the loading mechanism” corresponds to the “second data” in the present disclosure. The chip parameter includes a parameter of a current (which is also called a “test current” below) that flows by application of a test identical to a voltage for electrophoresis (that is, a test voltage) to an electrophoresis flow channel in microchip 5 by power supply portion 26.

Storage unit 386 stores a normal range of each parameter. Updating unit 383 determines whether or not the parameter obtained by obtaining unit 382 belongs to the normal range. Updating unit 383 updates the flag on condition that the parameter does not belong to the normal range.

In general, flag F1 is associated with new microchip 5. Updating unit 383 updates flag F1 to flag F2 on condition that a parameter of microchip 5 with which flag F1 is associated does not belong to the normal range. Updating unit 383 updates flag F2 to flag F3 on condition that a parameter of microchip 5 with which flag F2 is associated does not belong to the normal range. When the parameter not belonging to the normal range has come to belong to the normal range, updating unit 383 updates flag F2 to flag F1.

An updating condition for updating the flag may be set to any condition so long as the condition relates to a parameter not belonging to the normal range. For example, the updating condition may be satisfied when the number of parameters not belonging to the normal range reaches a prescribed number. Alternatively, for example, the updating condition may be satisfied when the number of times that a parameter does not belong to the normal range reaches a prescribed number.

Determination unit 384 determines whether or not microchip 5 satisfies the performance criterion. Cleaning control unit 388 controls cleaning mechanism 500 to perform second cleaning based on a result of determination by determination unit 384. For example, when flag F1 is associated with microchip 5, determination unit 384 determines that first cleaning of microchip 5 is required whereas second cleaning is not required. In this case, cleaning control unit 388 controls cleaning mechanism 500 to perform first cleaning of microchip 5.

For example, when flag F2 is associated with microchip 5, determination unit 384 determines that first cleaning and second cleaning are required for microchip 5. In this case, cleaning control unit 388 controls cleaning mechanism 500 to perform first cleaning and second cleaning of microchip 5.

For example, when flag F3 is associated with microchip 5, determination unit 384 determines that microchip 5 is unusable. In this case, controller 38 notifies a user that microchip 5 is unusable. Typically, controller 38 has display 80 show a “character image to the effect that microchip 5 is unusable.”

[As to Parameter]

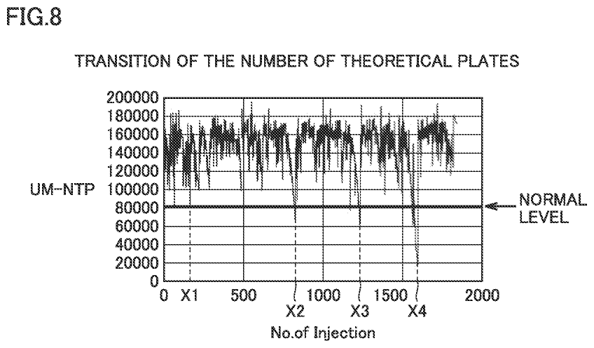

Each parameter will now be described. FIG. 8 is a diagram for illustrating the number of theoretical plates as an electrophoresis parameter. FIG. 8 is a diagram showing an exemplary number of theoretical plates of a high-molecular-weight marker (UM) for electrophoresis of a reference sample. In the example in FIG. 8, the ordinate represents the number of theoretical plates and the abscissa represents the number of times of analysis. The normal range (in the example in FIG. 8, a normal level) is set to 80000 or higher. In the example in FIG. 8, the number of theoretical plates is larger than the normal level when the number of times of analysis is X1. The number of theoretical plates is smaller than the normal level when the number of times of analysis is X2, X3, and X4.

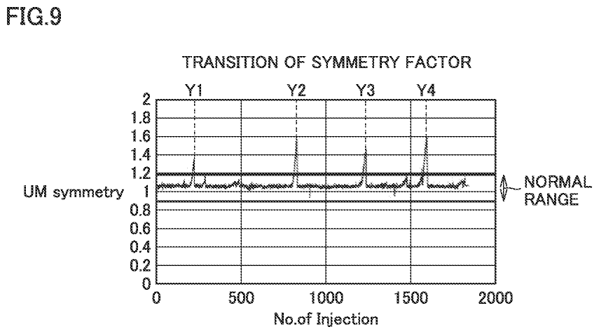

FIG. 9 is a diagram for illustrating a symmetry factor as an electrophoresis parameter. FIG. 9 is a diagram showing an exemplary symmetry factor of a high-molecular-weight marker (UM) peak when the reference sample is analyzed. In the example in FIG. 9, the ordinate represents a symmetry factor and the abscissa represents the number of times of analysis. The normal range of the symmetry factor is from 0.9 to 1.18. In the example in FIG. 9, the symmetry factor belongs to the outside of the normal range when the number of times of analysis is Y1, Y2, Y3, and Y4.

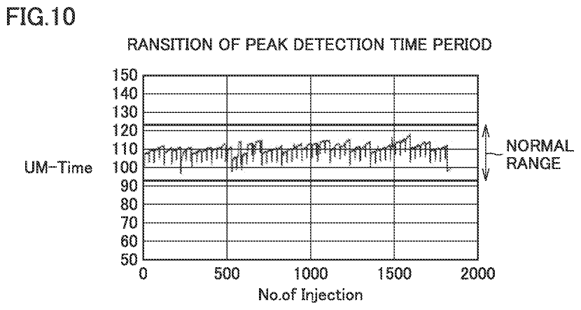

FIG. 10 is a diagram for illustrating a peak detection time period as an electrophoresis parameter. The peak detection time period refers to a time period from electrophoresis of the reference sample until detection of the peak (for example, the peak of the high-molecular-weight marker (UM) in electrophoresis of the reference sample) in electrophoresis. For electrophoresis apparatus 100, a time period for electrophoresis of a sample and a time period for electrophoresis of the reference sample are both set to 180 seconds. In the present embodiment, the normal range of the peak detection time period is from 94 seconds to 124 seconds. In the example in FIG. 10, in any case, the peak detection time period belongs to the normal range.

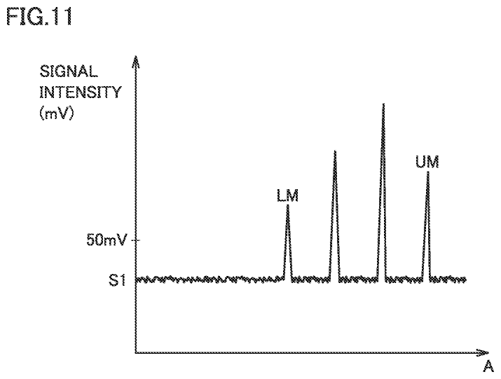

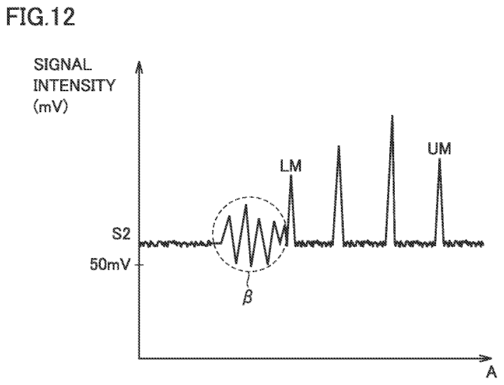

FIGS. 11 and 12 are diagrams showing signal intensity (a measurement value) of microchip 5. The abscissa in FIGS. 11 and 12 represents time and the ordinate represents signal intensity. The signal intensity represents intensity of a fluorescent signal and intensity of a signal received by optical fibers 32-1 to 32-4. LM in FIGS. 11 and 12 represents a marker of a lower limit marker substance and UM in FIG. 11 represents a marker of an upper limit marker substance. In the present embodiment, the normal range of a baseline of the signal intensity is not higher than 50 mV. The normal range of a noise level of the signal is not higher than 2 mV. In other words, as a difference between a maximum value and a minimum value of the signal intensity at a position other than the peak is not larger than 2 mV, the noise level of the signal belongs to the normal range.

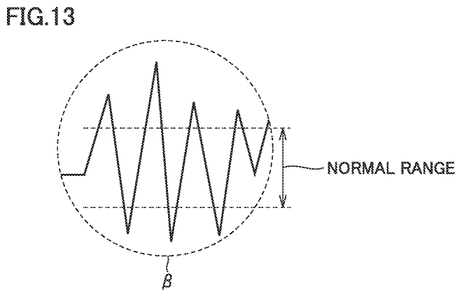

FIG. 11 is a diagram showing signal intensity of microchip 5 that satisfies a background (baseline intensity) criterion. In the example in FIG. 11, the baseline intensity is not higher than 50 mV defined as the reference. The normal range of the noise level of the signal is not higher than 2 mV. FIG. 12 is a diagram showing signal intensity of microchip 5 that does not satisfy the baseline intensity criterion. In the example in FIG. 12, the baseline of signal intensity is not lower than 50 mV. FIG. 13 is an enlarged view of a portion shown with β in FIG. 12 Since the difference between the maximum value and the minimum value of signal intensity at a position other than the peak is equal to or larger than 2 mV in the example in FIG. 13, the noise level does not belong to the normal range.

A buffer loading time period among chip parameters will now be described. Controller 38 controls pressurization and suction portion 16 to introduce a separation buffer into microchip 5 at 200 kilopascals from port #4 (see FIG. 4) of microchip 5. Electrophoresis apparatus 100 measures signal intensity corresponding to the separation buffer at any position P in the flow channel in microchip 5. Position P may be identical to a position of light reception in detection of fluorescence from the sample.

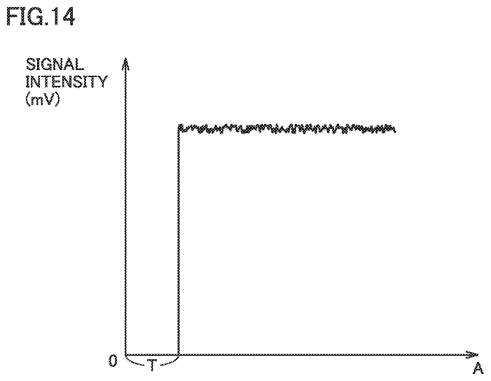

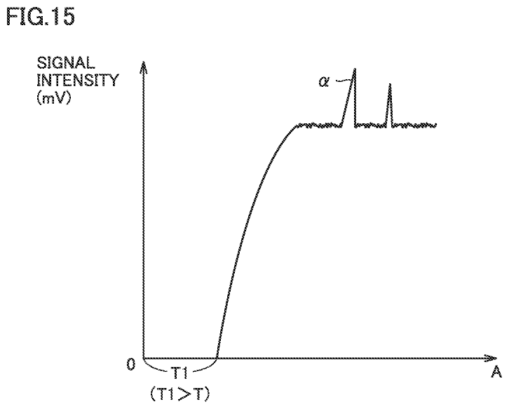

FIGS. 14 and 15 are diagrams showing signal intensity at position P. The abscissa in FIGS. 14 and 15 represents time and the ordinate represents signal intensity. Time 0 on the abscissa represents time of start of introduction of the separation buffer. FIG. 14 is a diagram showing signal intensity at position P in microchip 5 that satisfies the performance criterion. FIG. 15 is a diagram showing signal intensity at position P in microchip 5 that does not satisfy the performance criterion.

In microchip 5 that satisfies the performance criterion, when an assumed time period (a time period T in the example in FIG. 14) has elapsed since start of introduction (loading) of the separation buffer, the introduced separation buffer reaches position P. In microchip 5 that does not satisfy the performance criterion, in a region from port #4 to position P, a foreign matter (for example, remaining sample and separation medium) may be present. Therefore, in microchip 5 that does not satisfy the performance criterion, a time period from introduction of the separation buffer until arrival of the separation buffer to position P may be equal to or longer than the assumed time period. In microchip 5 that satisfies the performance criterion, a time period from start of introduction (loading) of the separation buffer until signal intensity at position P plateaus is shorter than the loading time period as the normal range. In microchip 5 that does not satisfy the performance criterion, a time period from start of introduction of the separation buffer until signal intensity at position P plateaus is equal to or longer than a normal time period.

In microchip 5 that does not satisfy the performance criterion, air bubbles may be produced in the introduced separation buffer. As shown in FIG. 15, when air bubbles are produced, a spike signal α is generated. Information indicating whether or not air bubbles are produced in the introduced separation buffer is referred to as air bubble information below. The air bubble information is defined, for example, as “0” when no air bubbles are produced, and defined, for example, as “1” when air bubbles are produced. The normal range of the air bubble information is defined as “0”. In other words, the air bubble information while air bubbles are produced belongs to the outside of the normal range.

Electrophoresis apparatus 100 uses an amount of separation buffer (an exchange volume below) calculated by loading of the separation buffer continuously for a prescribed time period by the loading mechanism. As the loading mechanism loads the separation buffer continuously for a prescribed time period, the flow channel is filled with the separation buffer and ports #1 to #3 are also filled with the separation buffer. A capacitance sensor (not particularly shown) that senses a height of a fluid level of the separation buffer is provided in injection probe 8. Therefore, electrophoresis apparatus 100 can calculate the exchange volume based on a “volume of the separation buffer loaded into the flow channel” or a “volume based on the fluid level of the separation buffer at each of port #1 to port #3.” In the example in FIG. 6, controller 38 is described as obtaining all parameters. A processor different from controller 38, however, may calculate at least one of all parameters and controller 38 may obtain the calculated parameter. Alternatively, controller 38 itself may calculate at least one of all parameters and controller 38 may obtain the calculated parameter. For example, FIG. 6 shows that obtaining unit 382 of controller 38 obtains the calculated exchange volume as the chip parameter. Thus, the processor different from controller 38 may calculate the exchange volume and transmit the exchange volume to controller 38. Alternatively, controller 38 itself may calculate the exchange volume.

The exchange volume of microchip 5 that satisfies the performance criterion is within a proper range. The exchange volume of microchip 5 that does not satisfy the performance criterion is out of the proper range, for example, due to such a reason as decrease in exchange volume by an amount of pressure loss in the flow channel.

The chip parameter includes the test current described above. A test current value of microchip 5 that satisfies the performance criterion is within the normal range. The test current value of microchip 5 that does not satisfy the performance criterion is out of the normal range.

[Analysis Process by Electrophoresis Apparatus]

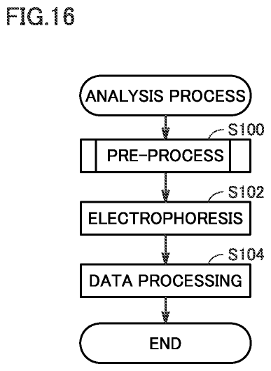

FIGS. 16 to 18 are diagrams showing an exemplary flow of an analysis process by electrophoresis apparatus 100. FIG. 16 is a diagram showing an exemplary flow of the analysis process. As a sample or the like is set in electrophoresis apparatus 100 and a user performs a start operation onto input portion 82, the analysis process starts.

In step S100, controller 38 starts a pre-process (cleaning of microchip 5 or the like). Then in step S102, controller 38 performs electrophoresis of a sample. Then in step S104, the controller provides a result of analysis of the sample by performing data processing based on a result of electrophoresis.

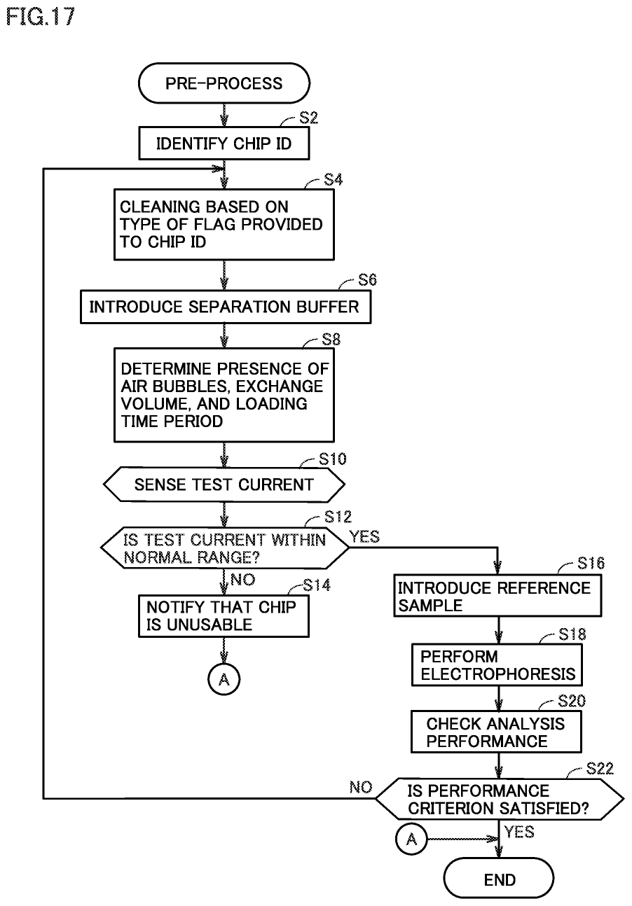

FIG. 17 is a diagram showing an exemplary flow of the pre-process in step S100. In step S2, controller 38 identifies chip ID of microchip 5 to be used in step S102. Chip ID is entered by a user, for example, before start of the analysis process in FIG. 16. Controller 38 identifies the entered chip ID. In a modification, a code (for example, a two-dimensional code) allowing identification of chip ID may be provided to microchip 5. As an ID sensor reads the chip ID, controller 38 may identify chip ID.

Then in step S4, determination unit 384 determines a type of a flag provided to the chip ID. Cleaning control unit 388 controls cleaning mechanism 500 to perform cleaning in accordance with the determined type of the flag. In the example in FIG. 7, cleaning mechanism 500 performs first cleaning, for example, onto microchip 5 with which flag F1 is associated.

Then in step S6, pressurization and suction portion 16 introduces the separation buffer into microchip 5. Then in step S8, updating unit 383 determines whether or not air bubbles have been produced in the introduced separation buffer (that is, determines whether or not spike signal α shown in FIG. 15 has been detected). In step S8, updating unit 383 determines whether or not the exchange volume described above belongs to the normal range. In step S8, updating unit 383 determines whether or not the buffer loading time period (see FIGS. 14 and 15) belongs to the normal range. Updating unit 383 updates the flag based on whether or not the air bubbles have been produced, whether or not the exchange volume belongs to the normal range, and whether or not the buffer loading time period belongs to the normal range in step S8. When at least one of observation of air bubbles, the exchange volume out of the normal range, and the buffer loading time period out of the normal range is detected, the process may return to step S6. In this case, the separation buffer that has already been introduced may be removed, and thereafter the separation buffer may newly be loaded. When the number of times of “processing for removing the separation buffer and thereafter newly loading the separation buffer” reaches a prescribed number (for example, two), updating unit 383 may update the flag of microchip 5 to flag F3.

Then in step S10, controller 38 senses the test current. Then in step S12, updating unit 383 determines whether or not the test current belongs to the normal range. When updating unit 383 determines the test current as not belonging to the normal range, it updates the flag of microchip 5 to flag F3 regardless of whether the flag has been set to any of flag F1 and flag F2. Concurrently, in step S14, controller 38 notifies that the microchip is unusable. In a modification, when updating unit 383 determines in step S12 the test current as not belonging to the normal range, for example, the process may return to step S6. Alternatively, when updating unit 383 determines the test current as not belonging to the normal range in step S12, it may update flag F1 to flag F2. In this case, the process may not proceed to step S14 but may proceed to step S16.

Then in step S16, controller 38 has the reference sample introduced into microchip 5. Then in step S18, controller 38 controls electrophoresis mechanism 520 to migrate the introduced reference sample. Then in step S20, controller 38 checks analysis performance. Processing in step S20 is such processing that obtaining unit 382 obtains the electrophoresis parameter and updating unit 383 determines whether or not each electrophoresis parameter belongs to the normal range. The electrophoresis parameters are as described with reference to FIGS. 8 to 13.

Updating unit 383 updates the flag based on a result in step S20. For example, when improvement in analysis performance of microchip 5 with which flag F2 is associated is confirmed in step S20, updating unit 383 updates flag F2 to flag F1. When lowering in analysis performance of microchip 5 with which flag F1 is associated is confirmed in step S20, updating unit 383 updates flag F1 to flag F2. For example, when at least one of five electrophoresis parameters is determined as not belonging to the normal range in processing in step S20 in spite of determination before processing in step S20 that all of the five electrophoresis parameters belong to the normal range, lowering in analysis performance is confirmed. When significant lowering in analysis performance of microchip 5 with which flag F1 or flag F2 is associated is confirmed in step S20, updating unit 383 updates flag F1 or flag F2 to flag F3.

In step S22, determination unit 384 determines whether or not microchip 5 satisfies the performance criterion. In step S22, determination unit 384 determines whether or not the performance criterion of microchip 5 is satisfied, for example, based on a result of confirmation in step S20. For example, when at least one of the five electrophoresis parameters is determined as belonging to the normal range in step S20, the performance criterion of microchip 5 may be determined as being satisfied. More specifically, when all of the five electrophoresis parameters are determined as belonging to the normal range, the performance criterion of microchip 5 may be determined as being satisfied. When determination as YES is made in step S22, the process proceeds to step S102 (see FIG. 16). When determination as NO is made in step S22, the process returns to step S4. In step S4, cleaning mechanism 500 performs cleaning treatment based on flag F2, that is, first cleaning and second cleaning. When flag F3 is determined as being associated with microchip 5 in step S20, controller 38 notifies that the microchip is unusable.

In a modification, in step S22, determination unit 384 may determine whether or not flag F1 is associated with microchip 5. When flag F1 is determined as being associated with microchip 5 in step S22, determination as YES is made in step S22. When flag F2 is determined as being associated with microchip 5 in step S22, determination as NO is made in step S22.

FIG. 18 is a flowchart showing a flow of processing for cleaning the microchip with which flag F2 is associated (that is, processing for performing both of first cleaning and second cleaning) in step S4. Initially, in step S202, cleaning mechanism 500 pressurizes and loads a cleaning solution into one reservoir while the flow channel and the reservoir in microchip 5 are empty. Then, in step S204, controller 38 stands by until a prescribed time period elapses. The prescribed time period refers to a time period for which the flow channel and the reservoir in microchip 5 are held as being in contact with the loaded cleaning solution. Then, in step S206, controller 38 removes the cleaning solution, for example, by driving suction nozzle 22.

Then in step S208, cleaning mechanism 500 pressurizes and loads cleaning water into one reservoir while the reservoir in microchip 5 is empty. Then in step S210, cleaning mechanism 500 dries the flow channel in microchip 5 by supplying pressurized gas from one reservoir. In performing first cleaning without performing second cleaning, processing in step S208 and step S210 is performed.

### SUMMARY

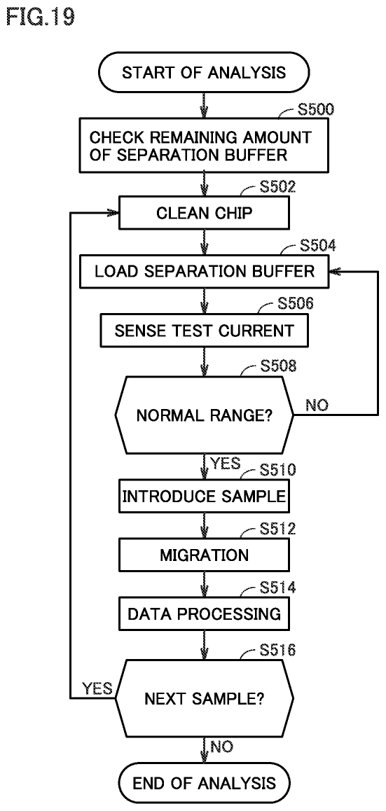

(1) FIG. 19 is a flowchart showing a flow of processing in an electrophoresis apparatus in a comparative example. Initially in step S500, the electrophoresis apparatus checks a remaining amount of the separation buffer. Then in step S502, the electrophoresis apparatus cleans the microchip. Then in step S504, the electrophoresis apparatus fills the microchip with the separation buffer. Then in step S506, the electrophoresis apparatus senses a test current by applying a voltage to the microchip. Then in step S508, the electrophoresis apparatus determines whether or not the sensed test current is within the normal range. When the electrophoresis apparatus determines the sensed test current as being out of the normal range (NO in step S508), the process returns to step S504. In step S504 to which the process returns from step S508, the loaded separation buffer is removed and thereafter the separation buffer is loaded again.

When the electrophoresis apparatus determines the sensed test current as being within the normal range (YES in step S508), the electrophoresis apparatus introduces a sample into the microchip in step S510. Then in step S512, the electrophoresis apparatus migrates the introduced sample. Then in step S514, the electrophoresis apparatus derives a result of analysis of the sample by performing data processing. Then in step S516, the electrophoresis apparatus determines whether or not there is a next sample to be analyzed. When the electrophoresis apparatus determines that there is a next sample to be analyzed (YES in step S516), the process returns to step S502. When the electrophoresis apparatus determines that there is no next sample to be analyzed (NO in step S516), the process ends.

In the example in FIG. 19, a user himself/herself should determine whether or not cleaning of the microchip with a cleaning solution is necessary. Therefore, the electrophoresis apparatus in the comparative example imposes burden on the user.

Electrophoresis apparatus 100 determines whether or not a criterion for performance of a device is satisfied (see, for example, determination in step S20 in FIG. 17). When electrophoresis apparatus 100 determines the criterion for performance of the device as not being satisfied, it performs second cleaning with a cleaning solution onto the device. Therefore, electrophoresis apparatus 100 can provide an efficient cleaning technique for retaining primary performance of a device to repeatedly be used without imposing burden on a user. Electrophoresis apparatus 100 can perform second cleaning with a cleaning solution onto a device without imposing burden on the user. When electrophoresis apparatus 100 determines the criterion for performance of the device as sufficiently being satisfied, it does not perform second cleaning with the cleaning solution onto the device. Therefore, electrophoresis apparatus 100 can avoid cleaning with a cleaning solution unnecessary for the device. In addition, electrophoresis apparatus 100 can provide a highly reliable result of analysis without lowering in work efficiency in analysis of a sample, by sensing a factor for variation in performance of analysis in electrophoresis of microchip 5 before analysis of the sample (an electrophoresis process for the sample). In the electrophoresis apparatus in the comparative example, a valuable sample may be wasted by continuing analysis of the sample without being aware of deterioration of performance of microchip 5. Furthermore, in the electrophoresis apparatus in the comparative example, adsorption of a component derived from a sample may proceed and a surface of microchip 5 may irreversibly be altered. Then, microchip 5 may not be reusable. In electrophoresis apparatus 100, when performance of microchip 5 has deteriorated (that is, when determination as NO is made in step S20), the sample is not analyzed. Therefore, electrophoresis apparatus 100 can prevent a valuable sample from being wasted. Accordingly, since electrophoresis apparatus 100 can thus prevent adsorption of a component derived from a sample from proceeding, it can also prevent irreversible alteration of the surface of microchip 5. Since electrophoresis apparatus 100 analyzes a sample with performance of microchip 5 being ensured, reliability of a result of analysis is improved. Since electrophoresis apparatus 100 does not have to perform treatment for cleaning microchip 5 after the user removes microchip 5, it can reduce works by a user.

(2) In electrophoresis apparatus 100, whether or not the criterion is satisfied is determined based on first data (electrophoresis data shown in FIGS. 8 to 13) obtained by electrophoresis of the reference sample. Therefore, whether or not microchip 5 satisfies the criterion can be determined based on data obtained by simulated electrophoresis.

(3) The electrophoresis data includes the number of theoretical plates (see FIG. 8) in electrophoresis of the reference sample. The electrophoresis data includes the symmetry factor (see FIG. 9) of the peak in electrophoresis of the reference sample. The electrophoresis data includes the peak detection time period (see FIG. 10) from electrophoresis of the reference sample until detection of the peak in electrophoresis. The electrophoresis data includes a height of the baseline (see FIGS. 11 and 12) of a measurement value in electrophoresis of the reference sample. The electrophoresis data includes the noise level (see FIGS. 12 and 13) of a signal in electrophoresis.

The electrophoresis apparatus can thus determine whether or not microchip 5 satisfies the criterion based on five types of electrophoresis data including the number of theoretical plates, the symmetry factor, the peak detection time period, the height of the baseline, and the noise level (see step S18 and step S20 in FIG. 17). Therefore, electrophoresis apparatus 100 can determine whether or not a device satisfies the criterion based on specific parameters in electrophoresis of the reference sample.

(4) Electrophoresis apparatus 100 updates the flag based on second data obtained by introduction of the separation buffer into microchip 5 (see step S8 in FIG. 17). Therefore, electrophoresis apparatus 100 can update the flag based on data obtained by simulated introduction of the separation buffer.

(5) The second data includes the buffer detection time period (see FIG. 14). As described with reference to FIG. 14, the buffer detection time period refers to a time period from introduction of the separation buffer into microchip 5 by the loading mechanism until detection of the separation buffer at prescribed detection position P in the flow channel. The second data includes air bubble information (information indicating whether or not air bubbles have been produced in the introduced separation buffer) (see spike signal a in FIG. 15). The second data includes the exchange volume.

Electrophoresis apparatus 100 thus updates the flag based on the buffer detection time period, the air bubble information, and the exchange volume (see step S8 in FIG. 17). Therefore, electrophoresis apparatus 100 can update the flag based on a specific parameter in introduction of the separation buffer.

For example, when a voltage is applied to microchip 5 with air bubbles having been produced in the separation buffer or with a foreign matter having been introduced in the separation buffer, idle migration occurs and a locally steep potential gradient is applied to microchip 5. Consequently, performance of microchip 5 may lower due to thermal load caused by Joule heat onto microchip 5. Since electrophoresis apparatus 100 updates the flag with the second data, application of the locally steep potential gradient can be prevented, and consequently lowering in performance of microchip 5 can be prevented.

(6) Electrophoresis apparatus 100 determines whether or not the test current belongs to the normal range (see step S12 in FIG. 17), and when the electrophoresis apparatus determines the test current as not belonging to the normal range, it determines microchip 5 as being unusable. Therefore, use of microchip 5 not appropriate for the electrophoresis process can be prevented. Processing for determining whether or not the test current belongs to the normal range is performed for determining whether or not the loading mechanism is normally operating, whether or not the separation buffer has correctly been selected, and whether or not an electrode terminal is normally functioning.

### Other Embodiments

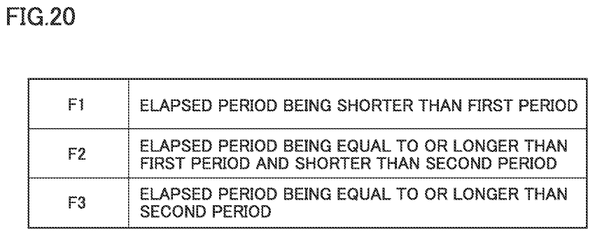

(1) In general, when a long time period has elapsed since manufacturing of microchip 5, analysis performance of microchip 5 tends to deteriorate. Then, updating unit 383 may update the flag based on a period elapsed since manufacturing of microchip 5 until the current time point (which is called an “elapsed period” below). FIG. 20 is a diagram showing correspondence between a flag and an elapsed period. Referring to FIG. 20, updating unit 383 associates microchip 5 the elapsed period of which is shorter than a first prescribed period with flag F1. Updating unit 383 associates microchip 5 the elapsed period of which is equal to or longer than the first prescribed period and shorter than a second prescribed period with flag F2. Relation of (the first prescribed period<the second prescribed period) is set. Updating unit 383 associates microchip 5 the elapsed period of which is equal to or longer than the second prescribed period with flag F3.

Cleaning mechanism 500 performs first cleaning and second cleaning onto microchip 5 the elapsed period of which is equal to or longer than the first prescribed period and shorter than the second prescribed period. Therefore, electrophoresis apparatus 100 can restore the deteriorated analysis performance of microchip 5. Electrophoresis apparatus 100 associates microchip 5 the elapsed period of which is equal to or longer than the second prescribed period with flag F3 indicating being unusable. Therefore, electrophoresis apparatus 100 can have a user recognize prohibition of use of microchip 5 performance of which is difficult to restore in spite of cleaning.

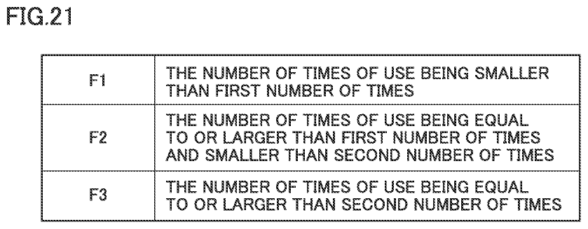

(2) In general, when the number of times of use since manufacturing of microchip 5 is large, analysis performance of microchip 5 tends to deteriorate. Then, updating unit 383 may update the flag based on the number of times of use of microchip 5 (the number of times of use for electrophoresis). FIG. 21 is a diagram showing correspondence between a flag and the number of times of use. Referring to FIG. 21, updating unit 383 associates microchip 5 the number of times of use of which is smaller than a first number of times with flag F1. Updating unit 383 associates microchip 5 the number of times of use of which is equal to or larger than the first number of times and smaller than a second number of times with flag F2. Relation of (the first number of times<the second number of times) is set. Updating unit 383 associates microchip 5 the number of times of use of which is equal to or larger than the second number of times with flag F3.

Cleaning mechanism 500 performs first cleaning and second cleaning onto microchip 5 the number of times of use of which is equal to or larger than the first number of times and smaller than the second number of times. Therefore, electrophoresis apparatus 100 can restore the deteriorated analysis performance of microchip 5. Electrophoresis apparatus 100 associates microchip 5 the number of times of use of which is equal to or larger than the second number of times with flag F3 indicating being unusable. Therefore, electrophoresis apparatus 100 can have a user recognize prohibition of use of microchip 5 performance of which is difficult to restore in spite of cleaning.

(3) Cleaning mechanism 500 may perform third cleaning onto microchip 5. Third cleaning refers to cleaning based on a mechanism different from second cleaning. Third cleaning may include cleaning longer in cleaning time period than second cleaning. Third cleaning may include cleaning larger in number of times of cleaning than second cleaning. Third cleaning may include cleaning with a specific cleaning solution higher in degree of cleaning than a cleaning solution used in second cleaning. Third cleaning may use a cleaning solution to be used in second cleaning and a specific cleaning solution (for example, a second cleaning solution accommodated in second cleaning portion 27 in FIG. 2) together.

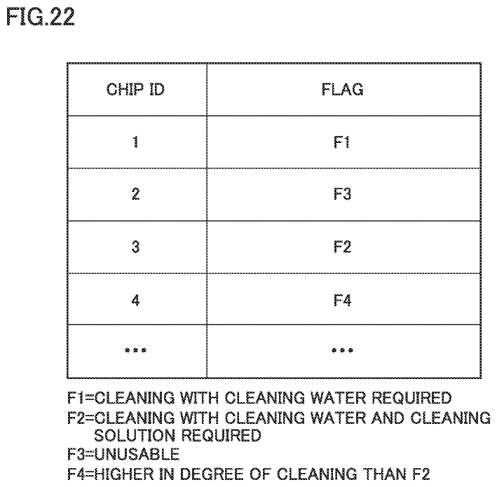

FIG. 22 is a diagram for illustrating third cleaning. The example in FIG. 22 shows a flag F4 as a flag corresponding to third cleaning. Flag F4 is associated with microchip 5 with chip ID 4. Flag F4 indicates a higher degree of deterioration than microchip 5 with which flag F2 is associated and indicates a lower degree of deterioration than microchip 5 with which flag F3 is associated.

In step S4 in FIG. 17, cleaning mechanism 500 performs cleaning onto microchip 5 based on a type of the flag. In other words, cleaning mechanism 500 performs any of second cleaning and third cleaning based on information. Such an electrophoresis apparatus could more elaborately determine the degree of deterioration of microchip 5 and perform cleaning onto microchip 5 in accordance with the degree of deterioration.

(4) In general, a cleaning solution for removing a sample is different depending on a type of the sample. An electrophoretically migrated sample may remain in the flow channel in microchip 5. Then, cleaning mechanism 500 cleans microchip 5 used for electrophoresis by electrophoresis mechanism 520 with a cleaning method in accordance with the electrophoresed sample (that is, the sample that remains in the flow channel).

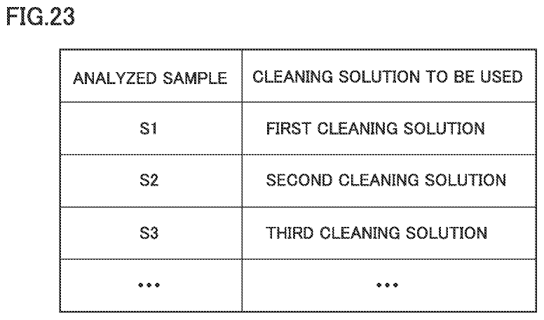

FIG. 23 is a diagram showing a cleaning method corresponding to each type of a sample. In the example in FIG. 23, when a sample 51 is the electrophoretically migrated sample, in the pre-process after electrophoresis, the first cleaning solution is used. When a sample S2 is the electrophoretically migrated sample, in the pre-process after electrophoresis, the second cleaning solution is used. When a sample S3 is the electrophoretically migrated sample, in the pre-process after electrophoresis, a third cleaning solution is used. Identification information of the electrophoretically migrated sample is stored, for example, in RAM 63 at the time point of end of electrophoresis. Controller 38 reads identification information of the sample stored in RAM 63 and determines a cleaning solution corresponding to the identification information. Such an electrophoresis apparatus could appropriately remove the electrophoretically migrated sample.

(5) In step S22, whether or not the performance criterion of microchip 5 is satisfied may be determined based on at least one of five electrophoresis parameters without using a flag. For example, when all of the five electrophoresis parameters are determined as belonging to the normal range, determination as YES may be made in step S22, and when at least one of the five electrophoresis parameters is determined as not belonging to the normal range, determination as NO may be made in step S22.

In step S22, whether or not the performance criterion of microchip 5 is satisfied may be determined based on at least one of the buffer loading time period, the air bubble information, and the exchange volume without using a flag. For example, when the buffer loading time period is determined as belonging to the normal range, determination as YES may be made in step S22, and when the buffer loading time period is determined as not belonging to the normal range, determination as NO may be made in step S22. For example, when the air bubble information is determined as indicating absence of air bubbles, determination as YES may be made in step S22, and when the air bubble information is determined as indicating presence of air bubbles, determination as NO may be made in step S22. For example, when the exchange volume is determined as belonging to the normal range, determination as YES may be made in step S22, and when the exchange volume is determined as not belonging to the normal range, determination as NO may be made in step S22. When the test current is determined in step S12 as belonging to the normal range without using a flag, determination as YES may be made in step S12, and when the test current is determined as not belonging to the normal range, determination as NO may be made in step S12.

When the number of times of use of the microchip is determined in step S22 as belonging to a proper range without using a flag, determination as YES may be made in step S22, and when the number of times of use is determined as not belonging to the normal range, determination as NO may be made in step S22.

When the elapsed period of the microchip is determined in step S22 as belonging to the proper range without using a flag, determination as YES may be made in step S22, and when the elapsed period is determined as not belonging to the normal range, determination as NO may be made in step S22.

(6) In the present embodiment, microchip 5 is described as an exemplary device. The device, however, may be another device so long as the device is used for electrophoresis. Examples of another device may include a capillary. The device may be applied to capillary electrophoresis (CE), liquid chromatography (LC), and flow injection analysis (FIA).

(7) In the present embodiment, electrophoresis apparatus 100 is described as performing the pre-process (processing in step S100) before analysis of a sample as described with reference to FIG. 16. Control device 70, however, may accept an operation to determine timing to perform the pre-process from a user. For example, electrophoresis apparatus 100 may perform the pre-process during the night.

(8) Electrophoresis apparatus 100 may increase the degree of cleaning as a degree of deviation between a parameter and a normal range of the parameter is large while the parameter belongs to the outside of the normal range. For example, when the number of theoretical plates representing the parameter is smaller than the normal level, cleaning higher in degree of cleaning may be performed in a case where a difference between the number of theoretical plates and the normal level (a deviation between the normal level and the number of theoretical plates) is at a first difference than in a case where the difference is at a second difference (the first difference>the second difference).

[Aspects]

A plurality of illustrative embodiments described above are understood by a person skilled in the art as specific examples of aspects below.

(Clause 1) An electrophoresis apparatus according to one aspect includes an electrophoresis mechanism that performs electrophoresis of a sample with a device, a control device that determines whether the device satisfies a criterion for performance of the device, and a cleaning mechanism that performs first cleaning for cleaning the device with cleaning water and second cleaning for cleaning the device with a cleaning solution different from cleaning water. The cleaning mechanism performs second cleaning onto the device when the device is determined as not satisfying the criterion.

According to the electrophoresis apparatus described in Clause 1, when a device is determined as not satisfying the criterion, second cleaning with a cleaning solution is performed on the device. Therefore, cleaning with a cleaning solution unnecessary for the device can be prevented.

(Clause 2) In the electrophoresis apparatus described in Clause 1, whether or not the criterion is satisfied is determined based on first data obtained by electrophoresis of the reference sample by the electrophoresis mechanism.

According to the electrophoresis apparatus described in Clause 2, whether or not the device satisfies the criterion can be determined based on data obtained by simulated electrophoresis.

(Clause 3) In the electrophoresis apparatus described in Clause 2, the first data includes at least one of the number of theoretical plates in electrophoresis of the reference sample, a symmetry factor of a peak in electrophoresis of the reference sample, a time period from start of electrophoresis of the reference sample until detection of the peak in electrophoresis, a height of a baseline of results in electrophoresis of the reference sample, and a noise level in electrophoresis of the reference sample.

According to the electrophoresis apparatus described in Clause 3, whether or not the device satisfies the criterion can be determined based on a specific parameter in electrophoresis of the reference sample.

(Clause 4) The electrophoresis apparatus described in any one of Clauses 1 to 3 further includes a loading mechanism that loads a separation buffer into the device, the device includes a flow channel for separating the sample by electrophoresis, and whether the criterion is satisfied is determined based on second data obtained by loading of the separation buffer into the device by the loading mechanism.

According to the electrophoresis apparatus described in Clause 4, whether or not the device satisfies the criterion can be determined based on data obtained by simulated loading of the separation buffer.

(Clause 5) The second data includes at least one of a time period from start of loading of the separation buffer into the device by the loading mechanism to detection of the separation buffer at a prescribed detection position in the flow channel, whether air bubbles are produced in the separation buffer loaded by the loading mechanism, and an amount of the separation buffer calculated by loading of the separation buffer for a prescribed time period by the loading mechanism.

According to the electrophoresis apparatus described in Clause 5, whether or not the device satisfies the criterion can be determined based on a specific parameter in loading of the separation buffer.

(Clause 6) In the electrophoresis apparatus described in any one of Clauses 1 to 5, the electrophoresis mechanism applies a voltage to the device, and whether the criterion is satisfied is determined based on a current that flows in accordance with the voltage applied by the electrophoresis mechanism.

According to the electrophoresis apparatus described in Clause 6, whether or not the device satisfies the criterion can be determined based on a current that flows in accordance with a voltage applied in a simulated manner.

(Clause 7) In the electrophoresis apparatus described in any one of Clauses 1 to 6, whether the criterion is satisfied is determined based on a period elapsed since manufacturing of the device.

In general, when a long time period has elapsed since manufacturing of a device, analysis performance of the device tends to deteriorate. According to the electrophoresis apparatus described in Clause 7, whether or not the device satisfies the criterion can be determined based on the elapsed period of the device. Therefore, the electrophoresis apparatus can make determination in conformity with this tendency.

(Clause 8) In the electrophoresis apparatus described in any one of Clauses 1 to 7, whether the criterion is satisfied is determined based on the number of times of use of the device.

In general, when the number of times of use of a device is large, the analysis performance of the device tends to deteriorate. According to the electrophoresis apparatus described in Clause 8, whether or not the device satisfies the criterion can be determined based on the number of times of use of the device. Therefore, the electrophoresis apparatus can make determination in conformity with this tendency.

(Clause 9) The electrophoresis apparatus described in any one of Clauses 1 to 8 further includes a storage unit that stores information in which the device and a degree of deterioration of performance of the device are associated with each other, and the cleaning mechanism is configured to perform third cleaning higher in degree of cleaning than the second cleaning and perform any of the second cleaning and the third cleaning based on the information.

According to the electrophoresis apparatus described in Clause 9, cleaning in accordance with the degree of deterioration can be performed on the device.

(Clause 10) In the electrophoresis apparatus described in any one of Clauses 1 to 9, the cleaning mechanism cleans the device used for electrophoresis with a cleaning method in conformity with the sample analyzed by the electrophoresis mechanism.

According to the electrophoresis apparatus described in Clause 10, cleaning in conformity with the analyzed sample can be performed.

Though an embodiment of the present invention has been described, it should be understood that the embodiment disclosed herein is illustrative and non-restrictive in every respect. The scope of the present invention is defined by the terms of the claims and is intended to include any modifications within the scope and meaning equivalent to the terms of the claims.

What is claimed is:

1. An electrophoresis apparatus comprising:
an electrophoresis mechanism that perform electrophoresis of a sample with a device;
a control device that determines whether the device satisfies a criterion for performance of the device; and
a cleaning mechanism that performs first cleaning for cleaning the device with cleaning water and second cleaning for cleaning the device with a cleaning solution different from the cleaning water, wherein
the cleaning mechanism performs the second cleaning onto the device when the device is determined as not satisfying the criterion.

2. The electrophoresis apparatus according to claim 1, wherein
whether the criterion is satisfied is determined based on first data obtained by electrophoresis of a reference sample by the electrophoresis mechanism.

3. The electrophoresis apparatus according to claim 2, wherein
the first data includes at least one of
the number of theoretical plates in electrophoresis of the reference sample,
a symmetry factor of a peak in electrophoresis of the reference sample,
a time period from start of electrophoresis of the reference sample until detection of the peak in the electrophoresis,
a height of a baseline of measurement values in electrophoresis of the reference sample, and
a noise level of a signal in electrophoresis of the reference sample.

4. The electrophoresis apparatus according to claim 1, further comprising a loading mechanism that loads a separation buffer into the device, wherein
the device includes a flow channel for separating the sample by electrophoresis, and
whether the criterion is satisfied is determined based on second data obtained by loading of the separation buffer into the device by the loading mechanism.

5. The electrophoresis apparatus according to claim 4, wherein
the second data includes at least one of
a time period from start of loading of the separation buffer into the device by the loading mechanism until detection of the separation buffer at a prescribed detection position in the flow channel,
whether air bubbles are produced in the separation buffer loaded by the loading mechanism, and
an amount of the separation buffer calculated by loading of the separation buffer for a prescribed time period by the loading mechanism.

6. The electrophoresis apparatus according to claim 1, wherein
the electrophoresis mechanism applies a voltage to the device, and
whether the criterion is satisfied is determined based on a current that flows in accordance with the voltage applied by the electrophoresis mechanism.

7. The electrophoresis apparatus according to claim 1, wherein
whether the criterion is satisfied is determined based on a period elapsed since manufacturing of the device.

8. The electrophoresis apparatus according to claim 1, wherein
whether the criterion is satisfied is determined based on the number of times of use of the device.

9. The electrophoresis apparatus according to claim 1, further comprising a storage unit that stores information in which the device and a degree of deterioration of performance of the device are associated with each other, wherein
the cleaning mechanism is configured to perform third cleaning higher in degree of cleaning than the second cleaning, and perform any of the second cleaning and the third cleaning based on the information.

10. The electrophoresis apparatus according to claim 1, wherein
the cleaning mechanism cleans the device used for electrophoresis with a cleaning method in conformity with the sample analyzed by the electrophoresis mechanism.
